(19) United States
(12) Patent Application Publication
(10) Pub. No.: US 2016/0193816 A1
(43) Pub. Date: Jul. 7, 2016

(54) VAPOR BARRIER TAPE DISPENSER AND METHOD

(71) Applicant: Gregory H. Carpenter, Clements, CA (US)

(72) Inventor: Gregory H. Carpenter, Clements, CA (US)

(21) Appl. No.: 14/984,949

(22) Filed: Dec. 30, 2015

Related U.S. Application Data
(60) Provisional application No. 62/124,830, filed on Jan. 5, 2015.
(60) Provisional application No. 62/143,898, filed on Apr. 7, 2015.

(51) Int. Cl. B32B 37/10; B65H 16/02; B65H 16/00; B32B 37/12; B32B 37/00

(52) U.S. Cl. CPC B32B 37/10; B32B 37/12; B32B 37/0053; B65H 16/005; B65H 16/02

(57) ABSTRACT

The dispenser includes an elongate handle with a bracket at a distal end thereof. The bracket rotatably supports a spindle which can removably hold a roll of tape thereon. A compression roller is also rotatably supported by the bracket. Tape is routed off of the roll mounted on the spindle and around the compression roller so that an adhesive side of the tape is facing downwardly and pressed between the compression roller and an underlying surface. A worker grasps the handle and presses down on the handle, especially with a lead hand, with sufficient force so that the compression roller presses down on the tape to securely attach the tape to surfaces adjacent to a line being followed with the dispenser, such as a seam between sheets of vapor barrier underlying a concrete foundation pour.

### CROSS-REFERENCE TO RELATED APPLICATIONS

This application claims benefit under Title 35, United States Code §119(e) of U.S. Provisional Application No. 62/124,830 filed on Jan. 5, 2015 and U.S. Provisional Application No. 62/143,898 filed on Apr. 7, 2015.

### FIELD OF THE INVENTION

The following invention relates to tape dispensers and particularly tape dispensers with elongate handles for facilitating taping along a surface spaced from hands of a worker, such as by walking behind the dispenser while it rolls on an underlying surface and applies tape thereto.

### BACKGROUND OF THE INVENTION

Often a concrete slab installation project calls for installation of a vapor barrier beneath the concrete slab. One common form of vapor barrier is elongate sheets of plastic material which is substantially impervious to vapor passage therethrough. Such plastic material is often called Visqueen (which is a trademark of British Polythene Limited of London, United Kingdom), and typically formed of polyethylene and more particularly typically low density polyethylene. Because the concrete to be poured is most typically wider than a width of rolls of such elongate sheets of vapor barrier material, multiple elongate sheets are laid down adjacent to each other with a seam therebetween. The seam typically has substantial overlap to help in resisting vapor migration between adjacent sheets. Also, it is often required, or at least beneficial, to tape these seams with a vapor barrier tape. Vapor barrier tape typically comes in relatively wide rolls (three to four inches wide) so that one to two inches of tape can be placed on each sheet adjacent the seam. The tape has an adhesive side and a back side which is typically non-adhesive.

In the prior art (FIG. 1) the tape is applied to the seam through following a highly labor intensive process including manually unrolling tape off of a hub and utilizing a second hand of a user to press down on the tape to secure the tape to the two vapor barrier sheets adjacent the seam. This process is particularly taxing on the knees and back of the worker who must crawl along the ground and continually reposition the body and the tape and press down on the tape to securely attach the tape to adjacent vapor barrier sheets. The taxing nature of this manual vapor barrier tape installation procedure is magnified significantly when large slabs of concrete are to be poured, with thousands of feet of seams to be taped.

While the invention disclosed herein is primarily provided to relieve a worker from this exceptionally taxing task of installing the vapor barrier tape to seams between adjacent sheets of vapor barrier material, the invention can also be directed to the positioning of adhesive tape to seams between other elongate sheets of material with seams therebetween which require or benefit from taping.

### SUMMARY OF THE INVENTION

With this invention, a dispenser is provided which can rollingly support a roll of tape as it is dispensed onto a seam, such as a seam between sheets of a vapor barrier, and allow the worker to remain standing. Furthermore, the dispenser allows for a high amount of force to be applied pressing the tape against the seam for firmly attaching the tape to the sheets of material, such as vapor barrier. In the embodiment disclosed herein, the dispenser includes a bracket with an elongate handle extending therefrom. The handle includes a distal end to which the bracket is attached and a proximal end opposite the distal end, typically closer to the hands of the worker than the distal end.

The bracket is a rigid structure which supports a spindle and a compression roller which can each rotate relative to the bracket. The spindle rotatably supports a roll of tape thereon, feeding the tape off of the roll and around the compression roller. The compression roller defines a lowermost portion of the dispenser which rolls along the ground, but with the tape routed between the compression roller and the seam which is against the ground beneath the roller.

In a preferred form, the bracket includes a top plate to which the distal end of the handle is attached. A pair of forks extend perpendicularly from this top plate to lower tips which are spaced from each other by a width at least as great as the compression roller. The compression roller includes an axle extending between the lower tips of the forks. A wheel is supported upon the axle so that the wheel can rotate relative to the forks. The wheel could rotate upon the axle or the wheel and axle could be fixed together with the axle rotating relative to the forks. In one embodiment the axle is supported by a journal bearing fixed to the lower tips of the forks for a low degree of friction between the wheel of the compression roller and the forks of the bracket. As an alternative, roller bearings could be utilized. The bearing is configured so that low rolling resistance is maintained even when a relatively high compression force is applied through the compression roller pressing the tape against the seam.

The bracket preferably includes an arm extending from one of the forks from a root to a free end. The free end of the arm supports the spindle thereon. The spindle includes a pivot with a mount upon the pivot. The mount can rotate relative to the free end of the arm, either by the mount and pivot being affixed to each other and rotating relative to the free end of the arm, or with the mount rotating relative to the pivot and with the pivot fixed to the free end of the arm. The spindle preferably is configured so that it is only attached through the one arm, and so that the mount is closed on an end adjacent the arm and open on an end opposite the arm. In this way, a roll of tape can be slid onto the mount by sliding toward the arm over the mount, and the roll of tape can be removed from the spindle by movement away from the arm and off of the mount.

The tape roll is mounted on the spindle so that a length of tape rolls off of a lower edge of the roll of tape when the roll of tape is on the spindle. This leading edge of the roll of tape comes off of the roll adjacent the spindle and in a generally forward direction beneath the spindle and with an adhesive side of the tape facing at least partially upwardly. The tape then wraps around the compression roller with a backside of the tape in contact with the wheel of the compression roller. The adhesive side of the tape is thus presented against the seam of vapor barrier or other sheet-like material being joined together, or other seam being spanned by the tape.

In utilizing the dispenser, a worker first places a roll of tape onto the spindle and routes a length of tape off of the spindle, and around the compression roller, and contacting the seam to be taped. The compression roller is then pressed down onto this seam with the tape tight against the seam or other line to be taped. The worker then walks along the seam or other line to be taped pressing the compression roller rotatably supported by the bracket down against the ground and in front of the worker in a generally forward direction, following the seam or other line. As the tape is dispensed, the worker can conveniently step upon the tape to further ensure that the tape has been securely fastened to underlying structures being taped together. Preferably, the worker has hands thereof spaced about one foot from each other and with a lead hand at least two feet away from the bracket. More preferably, the lead hand of the worker is at least three feet away from the bracket. The worker preferably bends at the waist with the lead hand extending downwardly and applying a downward force on the handle through the lead hand. This downward force applied with the lead hand is preferably at least about one hundred newtons (approximately twenty pounds). A rearward reference hand is also held by the worker at least a foot behind the lead hand. This reference hand can be held steady or apply an upward force. With the worker's hands one foot apart and with the lead hand three feet away from the roller of the dispenser, summing the torques about the reference hand establishes that twenty foot pounds of torque are applied by the worker, resulting in five pounds of force being applied by the compression roller upon the tape. The worker can conveniently apply at least twenty pounds through the lead hand merely by leaning forward at the waist and allowing weight of a torso of the worker to be supported by the lead hand of the worker while walking forward behind the bracket of the dispenser. Furthermore, the worker can utilize the handle as a sighting guide. By keeping the elongate handle aligned with a linear seam, it is easy for the worker to follow such a linear seam, even if the tape is relatively narrow. Also, the worker's eyes can be conveniently trained to not only guide the dispenser along the seam but also to look downwardly where the tape has been applied and provide a visual inspection to ensure that the seam has been accurately covered by the tape. Finally, and especially if any defects in the taping job are identified, such as a crease in the tape or a section where the tape is not firmly attached over the seam, the worker can utilize the worker's feet to press the tape into proper contact across the seam or other line, either while continuing to apply tape with the dispenser, or while briefly stopping before recommencing taping with the dispenser.

### OBJECTS OF THE INVENTION

Accordingly, a primary object of the present invention is to provide a dispenser for easily, rapidly and securely applying tape upon a lower surface seam/line, such as a seam between sheets of vapor barrier.

Another object of the present invention is to speed up the process of attaching and sealing together sheets of vapor barrier with tape.

Another object of the present invention is to provide a dispenser for securely taping and sealing sheets of vapor barrier together.

Another object of the present invention is to provide a method for conveniently, rapidly and securely sealing a seam between sheets of vapor barrier together.

Another object of the present invention is to enhance the speed with which vapor barrier is properly positioned and prepared before pouring a slab of concrete.

Another object of the present invention is to provide a method for taping and sealing a seam between sheets of vapor barrier together which can be accomplished with a lesser number of workers and/or a lesser number of man hours and with lesser strain on individual workers.

Another object of the present invention is to provide a walk behind tape dispenser which is easy to control and position where desired.

Other further objects of the present invention will become apparent from a careful reading of the included drawing figures, the claims and detailed description of the invention.

### BRIEF DESCRIPTION OF THE DRAWINGS

FIG. 1 is a perspective view of a worker taping a seam between sheets of vapor barrier according to a prior art method.

FIG. 2 is a perspective view of the dispenser of this invention in use by a worker to tape sheets of vapor barrier together at a seam therebetween, and illustrating some of the details of the dispenser.

FIG. 3 is a perspective view of a portion of the dispenser and illustrating how a roll of tape is rotatably supported by the dispenser and pressed against a seam between sheets of vapor barrier when being used according to one method of this invention.

FIG. 4 is a side elevation view of that which is shown in FIG. 3.

FIG. 5 is a front elevation view of that which is shown in FIG. 3, and with no tape played off of the roll of the tape, to assist in revealing details of a bracket and compression roller thereof.

FIG. 6 is a bottom plan view of that which is shown in FIG. 5.

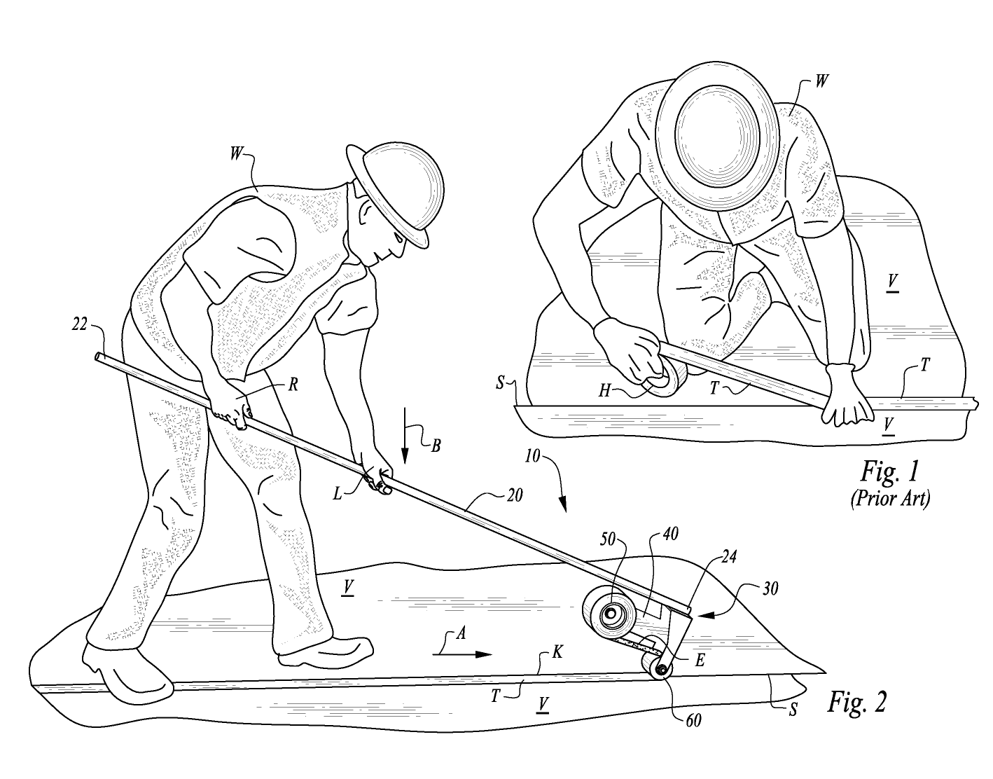

### DESCRIPTION OF THE PREFERRED EMBODIMENT

Referring to the drawings, wherein like reference numerals represent like parts throughout the various drawing figures, reference numeral 10 is directed to a dispenser for dispensing tape T along a line, such as a seam S between sheets of material, such as sheets of vapor barrier V (FIG. 2). The dispenser 10 is conveniently configured so that a worker W can walk behind the dispenser 10 and accurately, firmly and quickly apply tape T to seal together the seam S between the sheets of vapor barrier V. The dispenser 10 could also similarly be utilized for applying tape along other lines other than seams S between sheets of vapor barrier V.

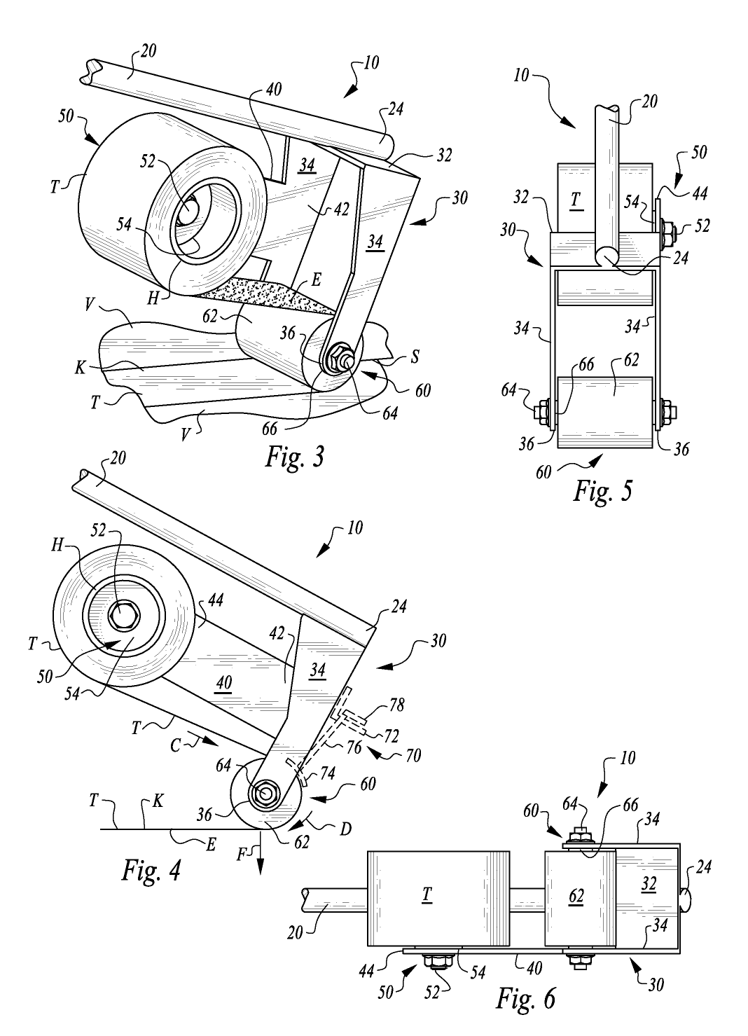

In essence, and with particular reference to FIGS. 2 and 3, basic details of the dispenser 10 of this invention are described, according to a preferred embodiment. The dispenser 10 includes an elongate handle 20 which can be handled by hands of a worker W including a lead hand L and a reference hand R. A bracket 30 is coupled to one end of the handle 20. The bracket 30 rotatably supports a spindle 50 thereon which can rotatingly hold a roll of tape and a compression roller 60 on a lowermost portion of the bracket 30. Tape T is routed off of a hub H rotatably supported by the spindle 50 and around the compression roller 60 with an adhesive side E of the tape T facing downwardly. The tape T is pressed between the compression roller 60 and a seam S or other line to be covered by the tape T.

More specifically, with this invention according to this preferred embodiment a method and apparatus are provided for simplifying the task of applying the tape T to the seam S between adjacent sheets of vapor barrier V material. The dispenser 10 is a tool including the elongate handle 20 with a proximal end 22 held by at least one hand of a user and a distal end 25 including the bracket 30 thereon. The bracket 30 is provided for dispensing the tape T off of the dispenser 10 and onto the ground over the seam S to be taped. This bracket 10 supports the roll of tape T supplied upon a hub H and also supports the compression roller 60. Each of these supports are preferably rotating supports.

In a preferred embodiment, this bracket includes forks 34 which extend down from a top plate 32 to lower tips 36. The forks 34 are wider adjacent the top plate and taper to a midpoint thereof before maintaining width down to the lower tips 36. The forks are preferably planar and parallel with each other and perpendicular to the top plate 32. The lower tips 36 are preferably curved with a semi-circular curvature.

The lower tips 36 support opposite ends of an axle 64 supporting the compression roller 60 thereon. The axle 64 is oriented preferably substantially perpendicular to a longest dimension of the handle 20. A wheel 62 of the compression roller 60 rolls on this axle 64, with the axle 64 preferably residing within a journal bearing 66 so that the wheel 62 of the compression roller 60 can rotate freely upon the axle 64.

The axle 64 could be stationary relative to the bracket 30 and the journal bearing 66 could rotate upon this stationary axle 64 along with the wheel 62 of the compression roller 60. Alternatively, the axle 64 could be fixed to the wheel 62 of the compression roller 60 and relative rotation could be accommodated between the axle 64 and the forks 34 of the bracket 30, so that the journal bearing 66 would be in the form of a rotating support where the axles 64 pass through holes in the forks 34.

In such an alternative, it is conceivable that some form of roller bearing could be utilized in place of, or in addition to the journal bearing 66. It is also conceivable that an amount of relative rotation would be accommodated both between the axle 64 and the forks 34 and between the axle 64 and the wheel 62 of the compression roller 60. As a further alternative, it is conceivable that the compression roller 60 could merely be static and completely or substantially non-rotating, so that it acts as a form of skid. In such an embodiment it would not have to be close to cylindrical in form. Most preferably, the compression roller 60 is able to roll and provides little or no resistance to rotation and rolling upon the ground.

A roll of tape T is supported upon the spindle 50 of the bracket 30 in this preferred embodiment, which is supported by the bracket 30, such as through an arm 40 extending rearwardly away from one of the forks 34 of the bracket 30. Most preferably, only a single arm 40 is provided which is rigidly secured to one of the forks 34 of the bracket 30 at a root 42 and extends to a pivot 52 at a free end 44 of the arm 40 most distant from the fork 34 to which the arm 40 is attached. The pivot 52 preferably has a mount 54 structure thereon which can rotate relative to the pivot 52. The roll of tape T includes a hub H which can frictionally fit over this mount 52, such as in a manner having the hub H of the tape T slide laterally onto the mount 52 along a line parallel with an axis of rotation of the pivot 32. The arm 40 preferably is coplanar with the fork 34 to which it is attached and has a constant width from the root 42 to the free end 44. The root 42 is preferably midway between the top plate 32 and the lower tip 36 of the fork 34 to which the root is affixed. Preferably, the arm 42 is formed with the fork 34 from a common piece of material, such as steel plate.

This axis of rotation of the pivot 52 is preferably substantially parallel with a central axis of the axle 64 and substantially perpendicular with the long axis of the handle 20. In such a configuration, the spindle 50 allows the tape T to be supported thereon and also for the tape T roll to rotate relative to the bracket 30. Preferably, an amount of friction resisting rotation of the spindle 50 relative to the bracket 30 is at least slightly greater than an amount of rolling resistance existing within the compression roller 60 relative to the bracket 30. In this way, when tape T in the tape roll is mounted on the spindle 50, and then the tape T is routed peeling off of the tape T roll, and then around the compression roller 60 (following arrows C and D of FIGS. 3 and 4), tension is maintained between the spindle 50 and the compression roller 60.

While the spindle 50 provides a preferred form of support for the tape T roll, other forms of supports could conceivably also be provided. While it is preferable that this spindle 50 or other tape T support is mounted directly to the bracket 30, it could be mounted to the handle directly, rather than to the bracket. It is also conceivable that the tape T roll could be carried by a separate worker or by the same worker W who is holding the handle 20 of the dispenser 10 tool (although typically less desired).

While a pair of forks 34 are preferably provided in the bracket 30 to support each end of the compression roller 60, it is conceivable that the bracket 30 could include a single fork 34 with the axle 64 cantilevering substantially perpendicularly away from such a single fork 34. As another alternative to the embodiment shown, a pair of arms 40 could be provided for support of the spindle 50, with one arm 40 extending from each fork 34, so that each end of the pivot 52 of the spindle 50 could be supported. In such an alternative, some degree of disassembly of the spindle 50 would be accommodated for loading of new rolls of tape T thereon periodically, such as through removal of the pivot 52 and mount 54, placing of the tape roll onto the mount 54, placing the tape T and mount 54 together back at the spindle 50 location, and replacing the pivot 52 along a central axis of the pivot 52, and finally with reassembly of fasteners at the end of the pivot 52. For both the pivot 52 and the axle 64 one embodiment could include a bolt with threads at an end opposite a head and with a nut removably attachable to the threads. Preferably, a shaft of the bolt is mostly unthreaded and provides a portion of the journal bearing 66. For the pivot 52, such a bolt could thread to female threads fixed to the free end 44 of the arm 40 with a head of the bolt most distant from the arm 40 and a tip of the bolt threading into connection with the free end 44 of the arm 40.

The wheel 62 of the compression roller 60 is preferably a hard rubber material which can flex slightly in a resilient fashion, but is substantially rigid, most preferably with a hardness similar to but slightly greater than that of typical automotive tires. For instance, with typical automotive tire tread having a shore A hardness of about 70 and roller skate and skateboard wheels having a shore A hardness of about 80-100, the hardness of the compression roller is preferably between shore A hardnesses of about 70 and 100, with greater hardnesses, such as up to 120 or higher (shore A) also being an option.

As an alternative, the wheel 62 of the compression roller 60 could be highly rigid, and formed from metal, plastic or other hard materials having hardnesses similar to that of a steel of average hardness. It is also conceivable that the compression roller wheel 62 could be selected to have a greater resilience than that of automotive tires. In one embodiment, compression rollers 60 with wheels 62 of different hardnesses and different materials could be selected by a user and removably attached to the bracket 30 so that a user would be able to customize the hardness of the compression roller wheels 62 to suit individual preference.

While the amount of friction in the axle 64 and journal bearing 66 supporting the compression roller 60 to the bracket 30 is preferably low to minimize resistance to rolling out of tape T around the compression roller 60, as an option an amount of friction can be designed into the compression roller 60, requiring the worker to work against the compression roller 60 resistance slightly. Such resistance helps the worker W (FIG. 2) to maintain balance while walking behind the dispenser 10 tool and applying substantial portions of body weight of the worker W down upon the handle 20 of the dispenser 10. The friction in the roller 60 can thus prevent the dispenser 10 tool from rapidly rolling out under these forces applied by the worker W and potentially causing the worker W to fall down behind the dispenser 10 tool.

An amount of friction provided between the compression roller 60 and the bracket 30 could in one embodiment be adjustable so that a worker W could adjust this amount of friction to accommodate worker W preference. A more skilled worker W or worker W with greater balance may appreciate lesser resistance to rolling of the compression roller 60 relative to the bracket 30, while a novice may appreciate greater friction at least initially, while learning to use the dispenser 10 tool. Furthermore, a stickiness of adhesive in the tape T and the degree to which it sticks to the back side K of the tape T when on the tape T roll, as well as friction within the spindle 50 also acts to resist motion of the dispenser 10 tool along the ground while applying tape T to the seam S between vapor barrier V sheets.

Conceivably, vapor barrier V tapes T of different styles or tapes T utilized for other purposes, having greater or lesser degrees of stickiness, can affect the amount of resistance to rolling of the dispenser 10 tool upon the ground. By making an amount of friction between the compression roller 60 and the bracket 30 adjustable, tape T stickiness variability can be accommodated by adjusting compression roller 60 resistance to rolling. For instance, with tape T that is highly sticky and/or spindles 50 which provide a high degree of resistance, it may be desirable to select a lesser resistance between the compression roller 60 and bracket 30.

In one embodiment, friction adjustment is through adjusting a force of a brake 70 pressing against the compression roller 60 (either on the sides or the rear where no tape T is located). The brake 70 can include a brake pad 74 pressing against the roller wheel 62. The pad 74 can be adjusted in position by rotating a bolt 76 carrying the pad 74 at a head or lever 78 above a bracket 72. The bracket 72 can be an “L-shaped” bracket spanning the forks 34 with a threaded hole passing therethrough for the bolt 76. As the bolt 76 rotates, friction between the pad 74 and roller wheel 62 is adjusted. The pad 74 can attach to a tip of the bolt 76 through a swivel joint to keep the pad 74 from rotating. The pad 74 can have a semi-cylindrical form matching a curvature of the roller wheel 62. In other embodiments, axles 64 and/or bearings 66 having different resistance characteristics can be swapped out to select the desired friction.

The spindle 50 of the bracket 30 is preferably spaced from the handle 20 and compression roller 60 sufficiently so that a full roll of tape T can be placed upon the spindle 50 and avoid impacting the handle 20 or compression roller 60. The spindle 50 is also elevated above the compression roller 60 sufficiently so that the spindle 50 (and roll of tape T thereon) avoids bumping into the ground or other structures. Typically, an amount of tape T provided on such a roll adds one to two inches to the radius of the tape T roll. The hub H of the tape T roll also typically has standard dimensions of one to two inches in radius so that the mount 54 of the spindle 50 preferably matches this radius (with a slight friction fit).

Tape T rolls having different hub H diameters can be accommodated by providing mounts M of different diameters (or removable adapters of different sized selectable from a kit of multiple adapter sizes to be placed therebetween). Tape T rolls which have a greater amount of tape T (such as more than two inches of radial length in the tape T roll) could be accommodated by positioning the spindle 50 further from the handle 20 or by providing an adapter attachable to the arm 40 of the bracket 30 (or to the handle 20 directly) which can be spaced further from the handle 20 to accommodate such a larger tape T roll.

The spindle 50 includes a mount 54 which preferably is a rigid structure with a central axis rotatably supported upon the pivot 52, such as through a cylindrical hole in the mount 54 overlying an axle at the pivot 52. The mount 54 preferably has a cylindrical portion and a side plate, with the cylindrical portion sized to have a friction fit with the inside of the hub H of the tape T roll. With the planar side plate on just one side, the tape T roll can be easily slid onto the cylinder opposite the side plate and abut the side plate. The cylinder could have ribs thereon to help hold the hub H to the mount 54.

With particular reference to FIG. 2, details of the operation of the dispenser tool according to one method are described. The worker W first fits a roll of tape T onto the spindle 50 and routes a free end of the tape T off of the hub H of the tape T roll (along arrow C of FIG. 4) and then about the compression roller (along arrow D of FIG. 4). An adhesive side E of the tape T can then be placed down upon a seam S between adjacent sheets of vapor barrier V, and with the axle 64 of the compression roller 60 oriented substantially perpendicular to a length of the seam S. Preferably, the seam S is near a midpoint of the tape T roll. Preferably, a starter amount of tape T is available past the compression roller 60 which can be placed manually down upon the seam S to start the utilization process for the dispenser 10 tool. In one embodiment, a foot of the worker W can press down onto this starter length of tape T to hold it in place as the installation process begins.

The worker W then walks (along arrow A) while pushing the dispenser 10 forward along the seam S. The handle 20 is elongate and straight in a preferred embodiment and can be lined up with the seam S so that the worker W can easily follow the seam S while walking behind the dispenser 10 tool, using the handle 20 as an alignment guide. Tape T is played off of the spindle 50 (along arrow C) and then around the compression roller 60 (along arrow D) and then is attached over the seam S.

The worker W preferably utilizes a reference hand R to hold a proximal end 22 of the handle 20, or a portion of the handle 20 closer to the proximal end 22 than to a distal end 24 of the handle 20. A lead hand L of the worker W is also placed upon the handle 20 and closer to the distal end 24 than the reference hand R. Most preferably, some spacing is provided between the reference hand R and lead hand L of the worker W (e.g. one foot or more). The worker W leans forward (and/or bends at the waist) and presses down with the lead hand L onto the handle 20 (with force along arrow B of FIG. 2). Preferably, this downward force is substantial and a spacing between the reference hand R and the lead hand L is sufficient so that a torque is provided generally having a magnitude measured by the product of the distance between the reference hand R and the lead hand L and the downward force provided by the worker (along arrow B).

Resistance to this torque applied by the worker W leaning down on the handle 20 while walking (along arrow A) is only resisted by the compression roller 60 and the ground beneath the compression roller 60, so that the compression roller 60 has the effect of pressing down onto the seam S and edges of the vapor barrier V sheets with a significant force (arrow F of FIG. 4). In particular, the opposing torque which opposes the torque applied by the hands R, L of the worker W is a product of the distance between the reference hand R of the worker W and the compression roller 60, with the force between the compression roller 60 and the ground. The greater the spacing between the worker's hands, the greater force F is. The greater the amount of weight of the worker W pressed down with the worker's lead hand L (along arrow B) the greater the force F is. Also, generally the shorter the handle 20, and thus the lesser the distance between the reference hand R of the worker W and the compression roller 60, the greater this force F is. It is desirable that the force F be sufficient so that the tape T has its adhesive side E securely attached to the vapor barrier V sheets on either side of the seam S as the dispenser 10 tool rolls over the seam S. To verify such full attachment of the tape T, the worker W can optionally drag a trailing foot over the tape T as the worker W walks behind the dispenser 10 tool.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A dispenser for taping a seam between vapor barrier sheets, the dispenser comprising in combination:
an elongate handle having a distal end opposite a proximal end;
a bracket attached to said handle at a location closer to said distal end than to said proximal end;
said bracket including a tape roll holding spindle rotatably supported by said bracket; and
a compression roller spaced from said spindle and rotatably supported by said bracket.

2. The dispenser of claim 1 wherein a pair of forks extend away from said handle to lower tips spaced from each other, said compression roller rotatably supported through said lower tips of said forks of said bracket.

3. The dispenser of claim 2 wherein an axle extends between said lower tips of said forks, said axle oriented perpendicular to said handle with a wheel located upon said axle having a surface thereof acting as said compression roller, said wheel rotatable relative to said forks.

4. The dispenser of claim 3 wherein said axle of said wheel is fixed to said wheel with said axle residing within a journal bearing rotatably supporting said axle relative to said forks.

5. The dispenser of claim 2 wherein an arm extends from one of said forks, said arm having a root opposite a free end with said root attached to one of said forks, said free end of said arm rotatably supporting said spindle thereon.

6. The dispenser of claim 5 wherein said spindle includes a pivot coupled to said free end of said arm and a mount coupled to said pivot, said mount configured to hold the roll of tape thereon.

7. The dispenser of claim 1 wherein said handle is at least three feet long between said proximal end and said dispenser.

8. The dispenser of claim 7 wherein said handle is at least four feet long between said proximal end and said dispenser.

9. A method for taping a seam between a pair of vapor barrier sheets, the method including the steps of:
positioning the vapor barrier sheets where desired with a seam therebetween;
attaching a roll of tape to a spindle supported by a bracket;
routing tape off of a roll of tape mounted on the spindle and about a compression roller rotatably supported by the bracket, along a pathway causing an adhesive side of the tape to face downward and to be in contact with the seam; and
pressing down on a handle extending from the bracket while walking behind the bracket and having the compression roller roll along the ground while dispensing tape onto the seam.

10. The method of claim 9 wherein said pressing down step includes two hands of the worker gripping the handle at different locations, including a lead hand closer to the dispenser and a reference hand further from the dispenser than a distance from the lead hand to the dispenser.

11. The method of claim 10 wherein said pressing down step includes pressing down with more force on the lead hand than on the reference hand.

12. The method of claim 11 wherein said pressing down step includes locating the hands of the worker at least about one foot apart, and with the lead hand of the worker at least two feet from the dispenser.

13. The method of claim 12 wherein said pressing down step includes locating the hands of the worker at least about one foot apart, and with the lead hand of the worker at least three feet from the dispenser.

14. The method of claim 12 wherein said pressing down step includes the worker bending at the waist forwardly and pushing down with a lead hand with at least about twenty pounds of force through the lead hand.

15. The method of claim 11 wherein said pressing down step includes the worker lifting up with the reference hand and pushing down with the lead hand.

16. A method for taping a seam between two items, the method including the steps of:
attaching a roll of tape to a spindle rotatably supported by a bracket which also has a compression roller rotatably supported thereon and an elongate handle extending therefrom;
routing tape off of the roll of tape mounted on the spindle and about the compression roller rotatably supported by the bracket, along a pathway causing an adhesive side of the tape to face downward when the tape is adjacent to the compression roller and to be in contact with the seam; and
pressing down on the handle extending from the bracket while walking behind the bracket and having the compression roller roll along the ground, while dispensing tape onto the seam beneath the compression roller.

17. The method of claim 16 wherein said pressing down step includes two hands of the worker gripping the handle at different locations, including a lead hand closer to the dispenser and a reference hand further from the dispenser than a distance from the lead hand to the dispenser.

18. The method of 17 wherein said pressing down step includes pressing down with more force on the lead hand than on the reference hand.

19. The method of claim 18 wherein said pressing down step includes locating the hands of the worker at least about one foot apart, and with the lead hand of the worker at least two feet from the dispenser.

20. The method of claim 19 wherein said pressing down step includes locating the hands of the worker at least about one foot apart, and with the lead hand of the worker at least three feet from the dispenser; and
wherein said pressing down step includes the worker bending at the waist forwardly and pushing down with a lead hand with at least about twenty pounds of force through the lead hand.
